(19) United States
(12) Patent Application Publication
(10) Pub. No.: US 2025/0166359 A1
(43) Pub. Date: May 22, 2025

(54) NON-PARAMETRIC SENSOR NOISE MODELING AND SYNTHESIS

(71) Applicant: SAMSUNG ELECTRONICS CO., LTD., Suwon-si (KR)

(72) Inventors: Ali MOSLEH, Markmaham, CA (US); Atin Vikram SINGH, Suwon-Si (KR); Jaeduk HAN, Suwon-Si (KR); Abhijith PUNNAPPURATH, North York (CA); Luxi ZHAO, Toronto (CA); Jihwan CHOE, Suwon-Si (KR); Marcus Anthony BRUBAKER, Toronto (CA); Michael Scott BROWN, Toronto (CA)

(73) Assignee: SAMSUNG ELECTRONICS CO., LTD., Suwon-si (KR)

(21) Appl. No.: 18/889,889

(22) Filed: Sep. 19, 2024

Related U.S. Application Data
(60) Provisional application No. 63/599,904, filed on Nov. 16, 2023.

(51) Int. Cl. G06V 10/774; G06V 10/82

(52) U.S. Cl. CPC G06V 10/774; G06V 10/82

(57) ABSTRACT

A method includes collecting a first set of images of a scene with a sensor in accordance with a first condition; collecting a second set of images of the scene with the sensor in accordance with a second condition; collecting one or more noise sample sets based on the first set of images and the second set of images; generating a calibrated noise model based on the one or more noise sample sets; and generating a noisy image by applying the calibrated noise model to a noise free image.

### CROSS-REFERENCE TO RELATED APPLICATION

This application claims priority to U.S. provisional application No. 63/599,904 filed on Nov. 16, 2023, the entire contents of which are incorporated herein by reference.

### BACKGROUND

### 1. Field

This disclosure is directed to modeling camera sensor noise.

### 2. Related Art

Image sensor measurements are affected by various degradations in the physical image formation process, such as optical aberrations, spatial sub-sampling in the color filter array (CFA), imperfect spectral sensitivities, and noise. Despite all the notable improvements in modern cameras, raw sensor readings become increasingly prone to noise with shrinking device sizes, and higher pixel densities. Therefore, solutions to image reconstruction problems like image denoising, super-resolution, deblurring, etc., depend heavily on raw image noise modeling to reduce the issues arising from noise.

Training AI-based RAW image processing models requires large paired datasets. However, collecting even small datasets is extremely challenging and non-trivial. For instance, the typical procedure to acquire noisy paired data is to take multiple noisy images of the same scene and generate a clean ground-truth image by pixel-wise averaging. In practice, effects like pixel misalignment and brightness mismatch are inevitable due to changes in lighting conditions and camera/object motion. This expensive and cumbersome exercise needs to be repeated with different camera sensors.

Capturing raw sensor images under various settings is quite challenging, especially under various illuminations and lighting conditions. This process requires adjusting camera settings, using tripods, setting up the scene, and likely finding different lighting conditions and environments. With such limitations, it becomes time-consuming to capture large-scale datasets of raw sensor images for training neural network models. Hence, there is a need for raw data synthesis to produce large-scale training datasets.

### SUMMARY

According to an aspect of the disclosure, a method comprises collecting a first set of images of a scene with a sensor in accordance with a first condition; collecting a second set of images of the scene with the sensor in accordance with a second condition; collecting one or more noise sample sets based on the first set of images and the second set of images; generating a calibrated noise model based on the one or more noise sample sets; and generating a noisy image by applying the calibrated noise model to a noise free image.

According to an aspect of the disclosure, an apparatus comprises a memory storing one or more instructions; at least one processor operatively coupled to the memory and configured to execute one or more instructions stored in the memory, wherein the one or more instructions, when executed by the at least one processor, cause the at least one processor to: collect a first set of images of a scene with a sensor in accordance with a first condition, collect a second set of images of the scene with the sensor in accordance with a second condition, collecting one or more noise sample sets based on the first set of images and the second set of images, generate a calibrated noise model based on the one or more noise sample sets, and generate a noisy image by applying the calibrated noise model to a noise free image.

According to an aspect of the disclosure, a non-transitory computer readable medium having instructions stored therein, which when executed by a processor cause the processor to execute a method comprising: collecting a first set of images of a scene with a sensor in accordance with a first condition; collecting a second set of images of the scene with the sensor in accordance with a second condition; collecting one or more noise sample sets based on the first set of images and the second set of images; generating a calibrated noise model based on the one or more noise sample sets; and generating a noisy image by applying the calibrated noise model to a noise free image.

### BRIEF DESCRIPTION OF DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, in accordance with embodiments of the present disclosure.

FIG. 2 is a block diagram of example components of one or more devices of FIG. 1, in accordance with embodiments of the present disclosure.

FIG. 3 illustrates an example imaging pipeline, in accordance with embodiments of the present disclosure.

FIG. 4 illustrates an example system for collecting samples and developing a noise model, in accordance with embodiments of the present disclosure.

FIG. 5 illustrates an example flowchart of a process for developing a noise model, in accordance with embodiments of the present disclosure.

FIG. 6 illustrates an example flowchart of a process for synthesizing a noisy image, in accordance with embodiments of the present disclosure.

FIG. 7 illustrates an example system of training a machine learning model, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

As understood by one of ordinary skill in the art, camera engineers need to generate datasets of raw sensor images for AI-based processing routines (e.g., nightmode, auto-white-balance, denoising). For example, an S22 wide-angle camera uses a particular sensor. Capturing a dataset of this sensor takes a lot of time and effort. Particularly, different imaging sensors have different sensitivities to light and different circuitry, and therefore, produce sensor images (called RAW images) that have different noise properties even if the images are captured under the same illumination and of the exact same scene. These issues are the reason that most AI models working on RAW images are sensor-specific. When a new sensor is manufactured, the training images for an AI-based algorithm needs to be recaptured for training new AI models. This process is a very time-consuming effort currently required by all camera engineers (e.g., at Google, Huawei, Samsung, Apple).

Accurate sensor noise models are essential for synthesizing noise on training images for deep neural networks (DNNs) targeting low-level vision tasks. Existing noise modeling methods are not accurate enough since it is difficult to precisely model all noise sources that stem from variations in circuit design and signal processing techniques.

Learning noise synthesis from real captured data on the other hand offers powerful representation capabilities. However, the accuracy of these methods depend on extensive image capturing of a wide variety of scenes.

Reconstructing images from raw data has evolved from traditional image processing methods to deep neural networks (DNNs) in recent years. As a result, there is now a growing demand for training sets containing images that accurately capture the noise present in modern small imaging sensors. The most common method of obtaining noisy-clean paired data is performed by capturing several noisy images of a scene and averaging out the noise to produce a clean ground-truth image. However, the scene illumination changes during data capturing and camera/object motion can cause color and brightness variations, as well as spatial misalignment. Furthermore, since noise characteristics are sensor-specific, this expensive and time-consuming process needs to be repeated for each camera sensor.

Therefore, most DNN-based raw image reconstruction methods use synthetic training datasets, which require sensor noise modeling and noise synthesis on clean images to create noisy inputs. Thus, image reconstruction task performance in real-world scenarios strictly depends on the discrepancy between synthetic noise and actual sensor noise. Existing noise modeling methods can be categorized into physics-based and DNN-based noise models.

Physics-based methods are used to model the statistical distribution of different noise sources based on the physical image formation process. These methods involve fitting model parameters using calibration data. However, it is impossible to accurately extract and model all noise sources due to the wide variation of noise sources on different cam-era sensors, caused by differences in circuit design and signal processing techniques. This is why early attempts at noise modeling were limited to simple additive white Gaussian noise (AWGN). However, as raw sensor noise is signal-dependent due to the physics of light, Gaussian-Poisson and heteroscedastic Gaussian models are the most common sensor noise models.

DNN-based methods for noise modeling have shown significant improvement by utilizing deep generative networks to learn noise synthesis from real captured data sources. Such models offer powerful representation capabilities and have shown promising results in noise synthesis on raw images. However, recent studies suggest that better noise synthesis accuracy can be achieved by per-forming thorough and careful sensor noise calibration for physics-based models. Therefore, there is an emerging interest in improving the learnability of DNN-based models by combining them with physics-based models.

Embodiments of the present disclosure are directed to a non-parametric method to model raw sensor noise. The noise model derived according to the embodiments of the present disclosure may be based on statistics derived from the image formation process, similar to physics-based models. However, unlike traditional models, the embodiments of the present disclosure do not rely on the typical assumptions about different noise components introduced during the process. Instead, the embodiments of the present disclosure achieve highly accurate noise models based on the observed distribution of noise at each pixel intensity level.

The embodiments of the present disclosure accurately model camera sensor noise. The embodiments of the present disclosure provide a systematic calibration method to collect a large sample set of sensor noise. The collected noise samples are used to build a probability mass function per sensor intensity level used to synthesize noise. Previous attempts at this problem rely on the typical assumptions about different noise components introduced during the imaging process and are not sufficiently accurate.

Based on the embodiments of the present disclosure, the camera sensor's sensitivity to noise may be characterized and modeled to synthesize noise on noise-free images (e.g., synthesize noisy image) to appear as if the noisy image were captured with this sensor. The embodiments of the present disclosure are very useful for product teams working on cameras and camera sensors, resulting in enhanced AI and machine learning models for camera users.

The embodiments of the present disclosure may be applied on RAW sensor images. These images may be specific to different makes and models of camera sensors (e.g., Sony, Omnivision, Samsung). Much of the recent development for cameras use AI methods that are sensor specific. The embodiments of the present disclosure are directed to reducing the need for training data that is sensor-specific, and allowing for data transformation and faster AI algorithm deployment for cameras.

The embodiments include a noise modeling operation that collects a burst of raw images of a specific target at a low ISO level, and collects another burst of the same target scene raw images at an ISO level which we intend to calibrate. The collection of low ISO images and the calibration ISO images may be used to collect noise sample sets per raw intensity level. The collected noise samples may be used to generate probability mass functions (PMFs) as the noise models per ISO setting.

The embodiments include a noise synthesis operation that may be performed based on the noise modeling operation. The noise synthesis operation converts the noise models to cumulative distribution functions (CDFs) and invert the CDFs. The inverted CDFs may be used in an inversion sampling process to randomly generate noise per intensity level. The randomly generated noise may be added to a clean raw image (e.g., noise free) to synthesize a sensor specific noisy raw image.

Accordingly, the embodiments of the present disclosure provide the significantly advantageous features of the ability to model camera sensor noise based on observed statistics of noise at each pixel intensity, rather than relying on common statistical assumptions. The embodiments of the present disclosure result in noise modeling data being generated in a controlled environment and does not require extensive image capturing of a wide variety of scenes.

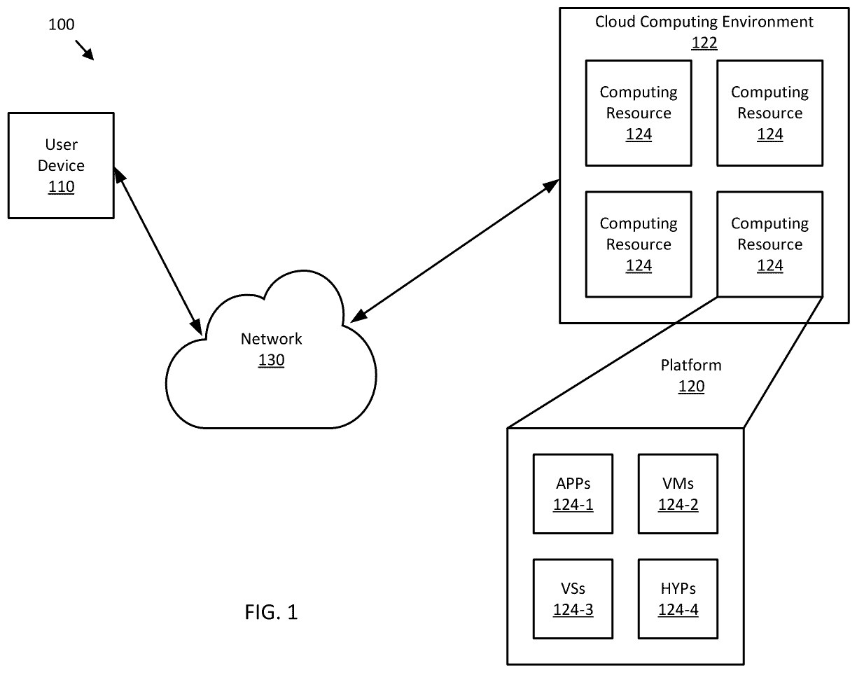

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (e.g., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSs) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

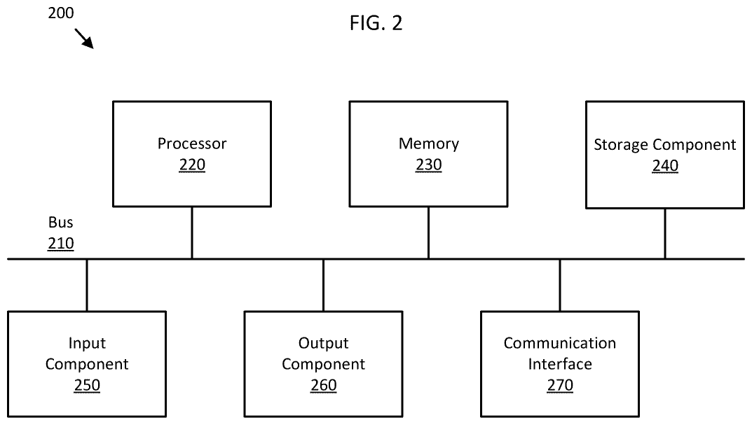

FIG. 2 is a block diagram of example components of one or more devices of FIG. 1. The device 200 may correspond to the user device 110 and/or the platform 120. The device 200 may be any other suitable device such as a TV, wall panel, etc. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

In one or more examples, the device 200 may be a controller of a smart home system that communicates with one or more sensors, cameras, smart home appliances, and/or autonomous robots. The device 200 may communicate with the cloud computing environment 122 to offload one or more tasks.

According to one or more embodiments, a non-parametric method is used for modeling raw sensor noise. Noise modeling is based on statistics derived from the image formation process, similar to physics-based models. However, unlike traditional models, the embodiments of the present disclosure do not rely on underlying assumptions about different noise components introduced during the process. Instead, the embodiments of the present disclosure are based on the observed distribution of noise at each pixel intensity level. A systematic calibration technique may be used to build a large sample set of noise. This is achieved by capturing a burst of images of a chart with uniform patches under controlled illumination at various ISOs and exposure values. The collected noise samples are used to fit a probability mass function (PMF) per intensity level, which is then used in an inversion sampling process to synthesize noise. The embodiments of the present disclosure provide a robust and accurate way of modeling sensor noise, without the need for complex parametric models.

For realistic image re-construction tasks, noise synthesis needs to be performed for much denser ISO values. This requires a much larger set of noise models than the ones obtained for the typical power of two nominal ISO values. To address the difficulty of such a dense noise calibration, a model interpolation method that approximates noise PMFs for arbitrary uncalibrated ISO settings is used, given a set of calibrated ISO settings per sensor intensity level. The high accuracy achieved for the proposed noise model interpolation method can also be attributed to the high accuracy of the underlying proposed non-parametric noise models.

A challenge with existing noise modeling methods is relying on either clean raw data or making assumptions that the underlying image is completely noise-free for noise synthesis. However, real-world images are often already noisy, and using them for noise synthesis can create a domain gap. On the other hand, the clean raw data may not be available for further noise augmentation. To address this challenge, the non-parametric noise models of the embodiments of the present disclosure are extended to a posterior noise model, which are then used to augment existing noisy image data by accurately synthesizing noise on the image data.

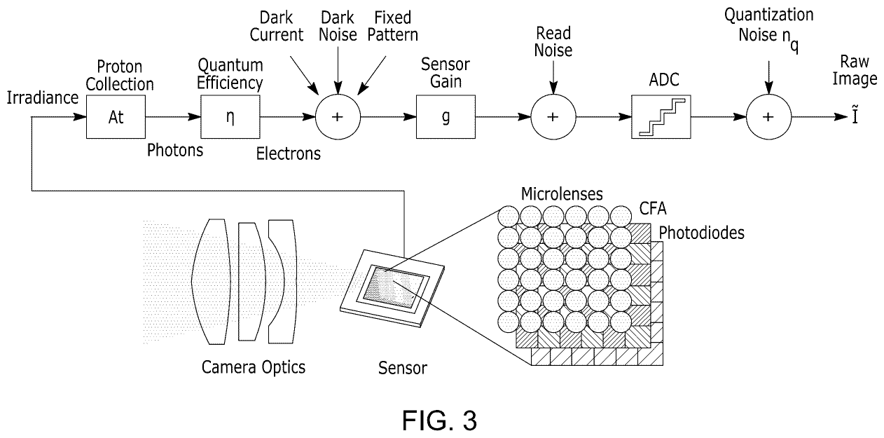

FIG. 3 illustrates an example imaging pipeline. From the modulation of the scene radiance on the surface of the sensor to the final digital storage, different types of noise are introduced. Some additive noise is photon-related, and some is independent of the incident light. However, the assumptions regarding different noise components and their distributions can vary from one sensor to another. Image formation in camera systems may follow the process shown in FIG. 3. The scene radiance modulated by the camera optical pipeline appears on the image sensor (e.g., CCD or CMOS), where photons go through a microlens array to improve light collection. Next, the incident light passes through a CFA to form a mosaic of the three RGB stimuli. Finally, photodiodes of the image sensor collect the color-filtered light and output a digital single-channel raw image. At the photodiodes layer, a potential well counts photons arriving at the sensor area A during the exposure time t, and converts the accumulated photons into electrons. This conversion is affected by the quantum efficiency of the CFA and the detector, denoted by f. Then, the electrons are amplified by a gain factor g, controllable by the ISO set-tings of the camera. Finally, an analog-to-digital converter (ADC) converts the modulated electrons to digital values.

During the process, electron noise is generated from different sources. Since the gain factor affects the noise distribution, it is crucial to divide the accumulated noise into gained noise as n_{g}, and read-out noise as nᵣ. The gained noise n_{g} mostly includes dark noise, dark current, and fixed pattern noise, while the read-out noise nᵣ is dominated by thermal noise. Quantization errors n_{q} introduced by the ADC are also added at the final stage before saving the raw image. The quantum nature of light also introduces some uncertainty in the collected photons. The number of incident photons and the relevant photon noise follow a Poisson distribution whose expectation is denoted by μₚ. Thus, the image formation process may be formalized as:

$$\tilde{I} = g ( {ημ}_{p} + η {n}_{p} ( {μ}_{p} ) + {n}_{g} ) + {n}_{r} + {n}_{q} , \qquad Eq . ( 1 )$$

where Î is the observed raw intensity per pixel, and nₚ (μₚ) denotes the photon noise which depends on the expected number of incident photons. Considering photo-electrons, e.g., I=gημₚ, Eq. (1) transforms to:

$$\begin{matrix}\tilde{I} = I + N ( I ) , \\ N ( I ) = g {ημ}_{p} ( I / g η ) + {gn}_{g} + {n}_{r} + {n}_{q} ,\end{matrix} \qquad Eq . ( 2 )$$

where I denotes the clean underlying intensity, and N(I) denotes the overall signal-dependent noise function.

The image formation model from Eq. (1) holds for a variety of different sensor architectures. However, underlying assumptions for the sensor-specific parameters and the distributions of noise components can vary significantly from one sensor to another. Thus, the embodiments of the present disclosure provide a non-parametric sensor noise model by collecting a sufficiently large number of noise samples and calibrating the overall signal-dependent noise N(I) introduced in Eq. (2) rather than modeling noise components individually. Noise characterization is different for the CFA channels, and it is largely affected by the gain factor. Therefore, according to one or more embodiments, noise may be modeled for color channels separately, per ISO setting.

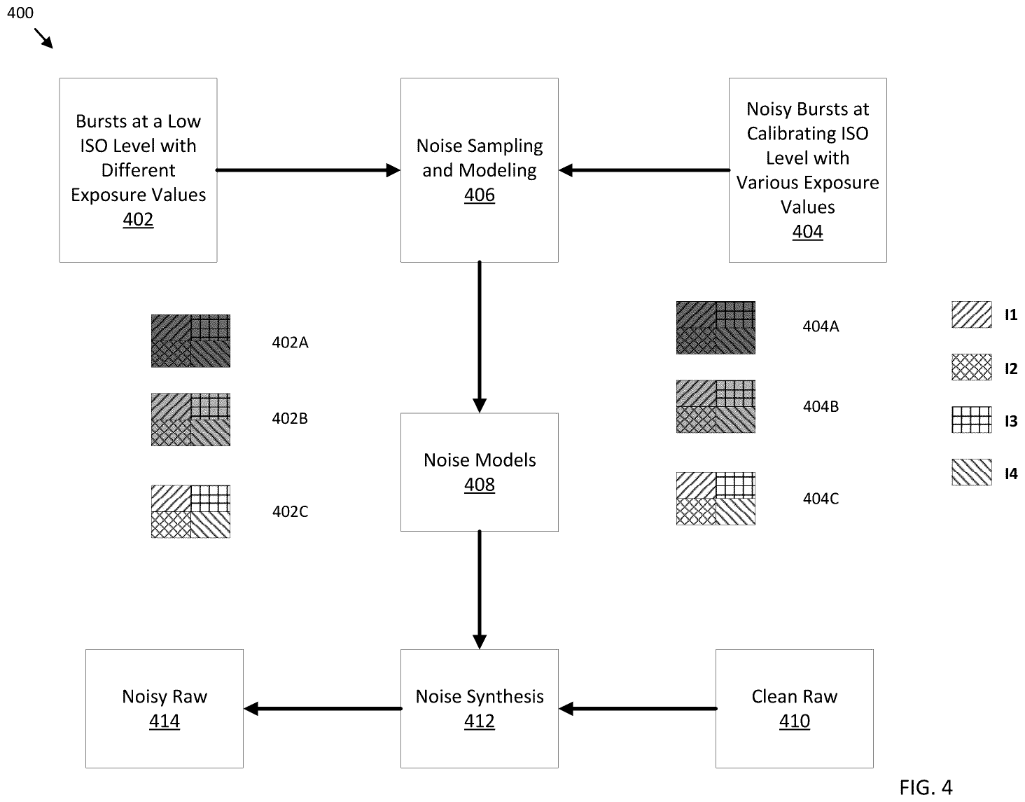

FIG. 4 illustrates an example system for collecting samples and developing a noise model, in accordance with embodiments of the present disclosure. In one or more examples, bursts at a first ISO level (e.g., low ISO level) with different exposure values 402 are collected and provided to a noise sample and modeling module 406. In one or more examples, noisy bursts at a second ISO level (e.g., calibrating ISO level) with various exposure values 404 are collected and provided to the noise sampling modeling module 406. FIG. 4 illustrates example 4×4 images with different exposure values. For example, images 402A, 402B, and 402C are captured at first, second, and third exposure values, respectively, at the first ISO level. Each of the images 402A, 402B, and 402C include pixels or regions comprising a plurality of pixels with intensity levels I1-I4. Images 404A, 404B, and 404C are captured at the first, second, and third exposure values, respectively, at the second ISO level. Each of images 404A, 404B, and 404C includes pixels or regions comprising a plurality of pixels with intensity levels I1-I4.

The noise sampling and modeling module 406 may develop one or more noise models 408 based on the collected samples. The noise models 408 and a clean raw image 410 may be provided to a noise synthesis module 412 that outputs a noisy raw image 414. For example, based on the noise models 408, the noise synthesis module 412 may add noise to the clean raw image 410 to generate the noisy raw image 414. In one or more examples, each of the modules illustrated in FIG. 4 may be implemented by the processor 220 (FIG. 2).

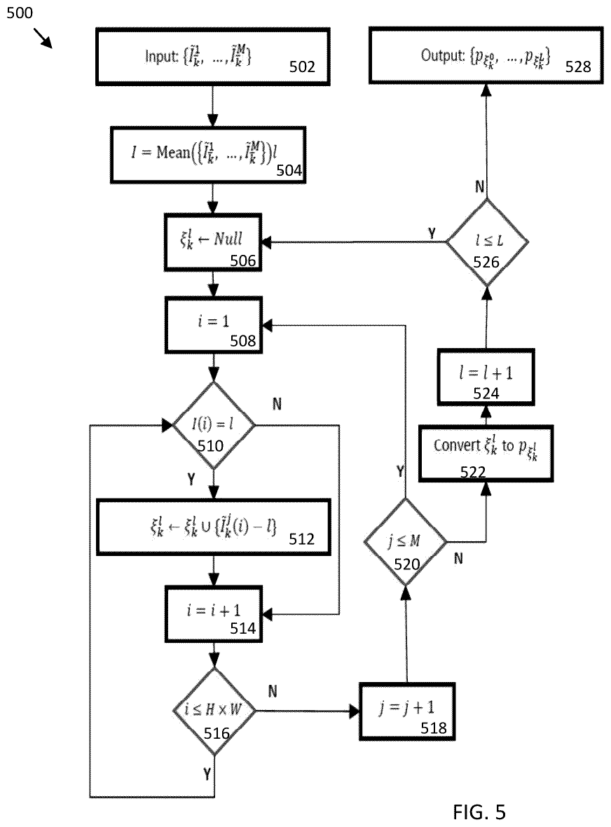

FIG. 5 illustrates a flowchart of an example process 500 for generating a noise model, according to one or more embodiments. The process 500 may use raw images captured at specialized controllable settings, e.g., capturing innumerous photon flux densities for scenes that contain uniform patches illuminated by a DC-light. In operation 502, a burst of M images of a color checker at a low ISO level denoted by κ̅ as {Ĩ1/θ, . . . , ĨM/κ} may be collected. In operation 504, a noise-free image I may be created by averaging the M images captured in operation 502. For example, given that the underlying clean signal can be defined as the expected value of E(·) of the noisy observations, the captures are averaged along temporal axis to form a clean image as I=E({Ĩ1/κ, . . . , ĨM/κ}) (operation 504). Accordingly, as a result, each corresponding pixel in each image is averaged. For example, if an image contains 256 pixels numbered [0]-[0255], and a burst contains 8 images, corresponding pixel [0] is averaged among all 8 images. This averaging process is repeated for the remaining pixels to form clean image I.

In one or more examples, a burst of color checker images denoted by {Ĩ1/κ, . . . , ĨM/κ}at an ISO level κ to be calibrated are collected. The ISO level κ may be at a higher ISO level than the ISO level used for the images collected in operation 502. In one or more examples, the same scene is used to capture the two bursts of images captured at the first and second ISO levels. In one or more examples, these noisy bursts are captured so that they are spatially aligned with the clean capture set.

In operations 506-520, I is inspected for each intensity level in which corresponding pixels are collected from the noisy bursts. As a result, each noise sample set per intensity level per ISO level is generated as:

$${ξ}_{κ}^{l} = \{ {\tilde{I}}_{κ}^{j} ( i ) - l \vert i ∈ \{ 1 , … , H \times W \} , I ( i ) = l , j ∈ \{ 1 , … , M \} \} , \qquad Eq . ( 3 )$$

where H×W denotes image size, i denotes pixel index, and 1 denotes sensor intensity level ranging from zero to sensor's white-level L, e.g., l ∈ {0, . . . , L}. In order to collect a reasonably large sample set for each intensity level representing various photon flux densities (∝ At) as in FIG. 2), burst images from a swipe of various exposure times are collected. This results in extremely dark pixels to almost fully saturated intensities.

In operation 506, the parameter ξl/κ is set to Null. In operation 508, the parameter i is set to 1. In operation 510, the condition of l(i)=l is checked. If the condition is satisfied, the process proceeds to operation 512 where the value of ξl/κ is set as ξl/κ←ξl/κU\tilde{l}j/κ(i)−l}. If the condition is not satisfied in operation 510, the process proceeds to operation 514 where the parameter i is incremented by one. The process proceeds to operation where is it determined whether the parameter i is less than or equal to H×W (e.g., index value i is within image boundary). If the condition is satisfied in operation 516, the process returns to operation 510. If the condition is not satisfied in operation 516, the process proceeds to operation 518 where the parameter j is incremented by one. The process proceeds to operation 520 where it is determined where j is less than or equal to M (e.g., number of images in a burst). If the condition is operation 520 is satisfied, the process returns to operation 508. If the condition in operation 520 is not satisfied, the operation proceeds to operation 522.

According to one or more embodiments, each noise sample set as ξl/κ may be used to fit a probability mass function (PMF) p_{ξl/κ}(n) where n ∈ [symbol] denotes noise value. The full set of PMFs for all the intensity levels of the sensor may form the ISO-specific non-parametric noise model as {pξo/κ(n), . . . , p_{ξL/κ}(n)}. In one or more examples, the color-filtered channels of imaging sensors have different sensitivities to the incident light. Therefore, noise calibration may be categorized per Bayer color channel of the sensor.

In operation 522, a frequency histogram of each noise sample set is generated and converted to a P_{ξL/κ}. In operation 524, the parameter l is incremented by one. In operation 526, it is determined whether l is less than or equal to L. If the condition in operation 526 is satisfied, the process returns to operation 506. If the condition in operation 526 is not satisfied, the process proceeds to operation 528 where the noise model is output as {p_{ξo/κ}(n), . . . , P_{ξL/κ}(n)} as the calibrated noise model for ISO level k.

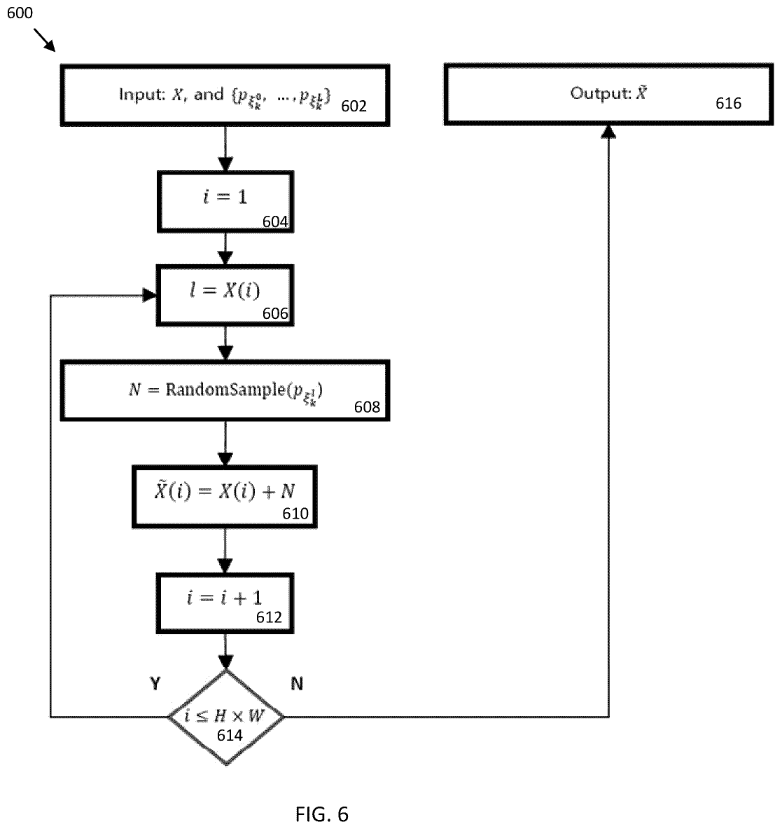

FIG. 6 illustrates a flowchart of an example process 600 for performing noise synthesis, according to one or more embodiments. The process 600 may use the noise models generated according to process 500 (FIG. 5).

According to one or more embodiments, given a clean image and calibrated noise models, noise may be synthesized via an inverse sampling transform (IST) method. The IST function denoted by IST(·) generates sample values randomly from a noise distribution by first building the corresponding CDFs of noise PMFs. Then, the CDFs are inverted such that a random value picked from a uniform distribution on [0, 1] corresponds to a noise value form the corresponding PMF. Therefore, for every pixel i in the given clean image X, the corresponding noisy pixel \tilde{X}(i) may be synthesized as:

$$\begin{matrix}\tilde{X} ( i ) = X ( i ) + N ( X ( i ) ) , \\ N ( X ( i ) ) ⟵ IST ( {p}_{{ξ}_{κ}^{X ( i )}} ( n ) )\end{matrix} \qquad Eq . ( 4 )$$

The IST technique may hold for continuous random variables. Since the PMFs in the noise model are generated from dense sample sets, the assumption that the PMFs still hold for discrete PMFs is relaxed.

In operation 602, a clean image X and the noise model {p_{ξo/κ}(n), . . . , p_{ξL/κ}(n)} are provided as input to the process. In operation 604, the parameter i is set to 1. In operation 606, the parameter l is set to X(i).

In operation 608, a random sample from PMF p_{ξl/κ}(n) is obtained as N. In operation 610, a noisy pixel in accordance with Eq. (4). In operation 612, the parameter i is incremented by 1. In operation 614, it is determined whether the parameter i is less than or equal to H×W (e.g., index value i is within image boundary). If the condition in operation 614 is satisfied, the process returns to operation 606. If the condition in operation 614 is not satisfied, the process proceeds to operation 616, where the noisy image X is output.

In one or more examples, an alternative to the calibration procedure in operations 502 and 504 to reduce the time and number of image captures is using one or more calibration charts with uniform/homogenous patches. Examples of such charts include, but not limited to, Color Checker, ISO-15739 noise test chart, etc. The data collection for {Ĩ_{l/κ}, . . . , Ĩ_{M/κ}} and {Ĩ_{l/κ}, . . . , Ĩ_{M/κ}} may be performed with a single calibration chart captured with different exposure values. In one or more examples, custom calibration charts may be devised that specifically target the need to capture a wide range of intensity ranges over the whole sensor.

In one or more examples, to reduce the memory/storage footprints of the noise models, an alternative to operation 522 may include fitting parameterized distribution functions such as Normal distribution to the collected noise samples. For example, instead of converting the collected noise sample sets to their actual probability distribution functions, one way to measure the variance and fit a Normal distribution function would be to replace operation 522 with the following operation using a variance of ξ_{l/κ} as follows: Eq. (5):

$${p}_{{ξ}_{κ}^{l}} = ( 0 , Variance of {ξ}_{𝓀}^{l} )$$

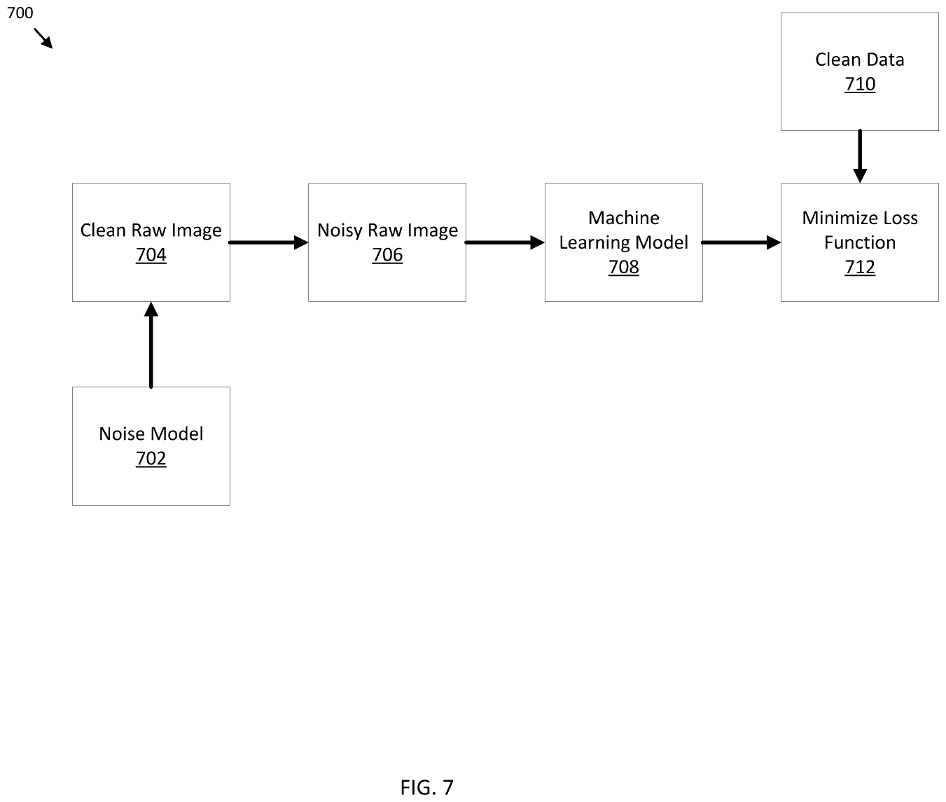

FIG. 7 illustrates an example system 700 for training a machine learning model. According to one or more embodiments, the noise model 702, such as the noise model from FIG. 5, is applied to a clean raw image 704 to generate a noise raw image 706. The noisy raw image 706 may be provided to a machine learning model 708 to remove the noise from the noisy image. The output of the machine learning model 708 may be compared with a clean data 710 using a minimize loss function 712. The clean data 710 may correspond to the clean raw image 704. If an output of the minimize loss function 712 exceeds a threshold, the machine learning model 708 may be updated to minimize the difference between the clean data 710 and the clean raw image. For example, one or more weights or parameters of the machine learning model 708 may be updated to minimize the difference between the output of the machine learning model 708 and the clean data 710. In one or more examples, the loss function may be mean square error loss or mean absolute error loss. In one or more examples, the machine learning model 708 may be a neural image signal processor (ISP) network.

Synthesizing realistic noise as an augmentation strategy for developing camera/sensor-specific application models may be limited in one of the two following ways. First, sensor noise modeling is often performed for a few ISO settings, e.g., some nominal power of 2 levels as {2ⁿ100|n ∈ N, 0≤n≤6}. However, in ubiquitous cameras, the additive system of photographic exposure (APEX) uses a wide range of ISO values to calculate exposure. Thus, realistic applications require noise models for a much larger number of ISO settings than the small set of nominal ones that are powers of 2. This poses a significant challenge as accurate noise modeling for each ISO level requires numerous captures, regardless of whether we are using DNN-based or physics-based approaches.

Second, existing noise synthesis methods for generating training data need noise-free raw images to apply Eq. (2). However, in many image restoration applications, ground-truth (clean) data is generated using approaches other than long-exposure photography. For instance, using a secondary high-end DSLR geometrically aligned with the main camera to capture ground-truth data is a common approach, especially if the task has to deal with blur effects. In another scenario, for full raw-sRGB rendering applications, using black-box rendering tools like Adobe Photoshop is one approach to obtain ground-truth data. In such cases, access to clean raw data for noise synthesis is difficult to obtain. On the other hand, such ground-truth data may be the results of many non-linear operations. Thus, approximating raw data through an inversion process poses an unavoidable domain gap in the synthesized data. Therefore, using a noise model that allows augmenting some calibrated noise on top of existing noisy raw images such that the augmented noise follows sensor characterizations is very valuable.

As described in further detail below, an interpolation method is developed to infer noise distributions for uncalibrated ISO levels. Furthermore, methods applying calibrated noise models to existing noisy captures to augment training datasets with new ISO raw images are disclosed.

According to one or more embodiments, under certain conditions and using calibration data, it is possible to approximate the variance of read-out noise and gained noise introduced in Eq. (1) along with the quantum efficiency parameter. Such a parameterized approach can be adopted for the heteroscedastic Gaussian noise modeling by solving a system of linear equations to estimate a noise model for uncalibrated ISO levels.

The noise modeling approach of the embodiments of the present disclosure may be based on actual sensor noise measurements. The calibrated noise statistics may be used to develop an interpolation approach to estimate uncalibrated PMFs as follows.

Let K denote a calibrated ISO level from the set of calibrated ISO levels {κmin, . . . , κₘₐₓ}, for each K, per intensity level l, the following statistics may be obtained:

$${σ}_{{ξ}_{𝓀}^{l}}^{2} = Var ( {ξ}_{𝓀}^{l} ) , {μ}_{{ξ}_{𝓀}^{l}} = E ( {ξ}_{κ}^{l} ) , {p}_{{ξ}_{κ}^{l}} ( n ) , \qquad Eq . ( 6 )$$

where Var(·) and E(·) denote the variance and expected value of the sample set, respectively. The normalized distribution of noise, whose mean and variance are 0 and 1, respectively, can be defined as:

$${p}_{{ξ}_{κ}^{l}} ( n ) = \frac{1}{{σ}_{{ξ}_{κ}^{l}}} {p}_{{ξ}_{κ}^{l}} ( \frac{n - {μ}_{{ξ}_{κ}^{l}}}{{σ}_{{ξ}_{κ}^{l}}} ) \qquad Eq . ( 7 )$$

In one or more examples, it is assumed that this normalized PMF has a similar characteristic function among calibrated ISO levels for each l, e.g., p_{ξl/κ}_{ₘᵢₙ}(n)≈ . . . ≈ p_{ξl/κ}_{ₘₐₓ}(n). For example, noise distributions per intensity level among different ISO levels are assumed to have similar-shaped PMFs which are different in their scales and means. This assumption allows us to approximate noise distributions for uncalibrated ISO levels through interpolating among calibrated noise variances and means. More precisely, for each set of calibrated noise distributions, curves are fitted to the measured variances and means as:

$$\begin{matrix}\{ {σ}_{{ξ}_{{𝓀}_{min}}^{l}}^{2} , … , {σ}_{{ξ}_{{𝓀}_{max}}^{l}}^{2} \} {⟶}^{curve fitting} {f}_{var} ( l , j ) \\ \{ {μ}_{{ξ}_{{𝓀}_{min}}^{l}} , … , {μ}_{{ξ}_{{𝓀}_{max}}^{l}} \} {⟶}^{curve fitting} {f}_{mean} ( l , j )\end{matrix} \qquad Eq . ( 8 )$$

The variances in Eq. (8) may be used to approximate the variance and mean of noise for uncalibrated ISO level j ∈ {j|j ∈ N, κₘᵢₙ≤j≤κₘₐₓ}. Then, for each unseen ISO level j, the noise PMF is approximated as:

$${p}_{{ξ}_{j}^{l}} ( n ) = \sqrt{{f}_{var} ( l , j )} {p}_{{ξ}_{𝓀}^{l}} ( ( n + {f}_{mean} ( l , j ) \sqrt{{f}_{var} ( i , j )} ) , \qquad Eq . ( 9 )$$

where p_{ξl/κ} is a normalized noise distribution from the set of calibrated ISO levels. The approximated PMF is then used in Eq. (6) to synthesize noise for the uncalibrated ISO level j. Given the calibrated noise models in the form of PMFs p_{ξl/1}(n₁), p_{ξl/2}(n₂) for two different ISO settings and Ĩ₁ as an observed image captured at the 1st ISO level, Ĩ₂ is simulated as an image at the 2nd ISO level. In one or more examples, noise p_{ξl/2}(n₂) may be directly sampled and applied on Ĩ₁. However, it cannot be ignore that Ĩ₁ is already contaminated with noise.

Therefore, the embodiments of the present disclosure model the noise to be added to the existing noisy image by accounting for the probability of the additive noise on top of the existing noise denoted by n₂−n₁ whose distribution characteristic function per intensity level l can be p_{ξl/2}(n₂−n₁). Thus, in one or more examples, the embodiments propose to simulate Ĩ₂ via sampling from p_{ξl/2}(n₂−n₁) as:

$${\tilde{I}}_{2} ( i ) = {\tilde{I}}_{1} ( i ) + IST ( {p}_{{ξ}_{2}^{l}} ( {n}_{2} - {n}_{1} ) ) \qquad Eq . ( 10 )$$

In one or more examples, for building p_{ξl/2}(n₂−n₁), an approximation of the clean intensity image, denoted by Î, may be used. This approximation may be used to pick the right PMFs corresponding to l, e.g., l≈Î(i) and also to approximate n₁ as n₁≈Î₁(i)−Ĩ(i). Therefore, a denoiser may be applied on the observation Î₁ to obtain Î. This approach results in a more accurate noise augmentation compared to naively applying the ISO setting 2 noise models on ISO setting 1 captures, e.g., I₂(i)=₁(i)+ITS(p_{ξl/2}(n₂)), or applying the ISO setting 2 noise models on approximated clean images, e.g., Ĩ₂(i)=Ĩ(i)+ITS(p_{ξl/2}(n₂)).

The embodiments have been described above and illustrated in terms of blocks, as shown in the drawings, which carry out the described function or functions. These blocks may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:
(1) A method performed by at least one processor, the method comprising: collecting a first set of images of a scene with a sensor in accordance with a first condition; collecting a second set of images of the scene with the sensor in accordance with a second condition; collecting one or more noise sample sets based on the first set of images and the second set of images; generating a calibrated noise model based on the one or more noise sample sets; and generating a noisy image by applying the calibrated noise model to a noise free image.
(2) The method according to feature (1), further comprising: inputting the noisy image into a machine learning model to generate an estimated noise free image; and updating the machine learning model based on comparing the estimated noise free image and the noise free image using a loss function.
(3) The method of feature (2), in which the machine learning model is a neural image signal processor (ISP) network.
(4) The method according to any one of features (1)-(3), in which the collecting the first set of images in accordance with the first condition further comprises: collecting a first burst of raw images of the scene with the sensor at a first International Organization Standardization (ISO) value, and in which the collecting the second set of images in accordance with the second condition further comprises: collecting a second burst of raw images of the scene with the sensor at a second ISO value higher than the first ISO value.
(5) The method of feature (4), in which the scene comprises a plurality of intensity values, and in which the collecting the first set of images in accordance with the first condition further comprises: generating a ground-truth image by averaging each image in the first burst of raw images at each intensity value.
(6) The method of feature (5), in which the collecting the one or more noise sample sets based on the first set of images and the second set of images further comprises: for each intensity level in the ground-truth image, collecting corresponding pixels from the second burst of images to form a noise sample set per intensity level.
(7) The method of feature (6), in which the generating the calibrated noise model based on the one or more noise sample sets further comprises: generating a frequency histogram for each noise sample set; and converting the frequency histogram for each noise sample set to a probability mass function as the calibrated noise model.
(8) The method of feature (7), in which the generating the noisy image further comprises: converting the calibrated noise model to one or more cumulative distribution functions; inverting the one or more cumulative distribution functions; performing, using the inverted one or more cumulative distribution functions, an inversion sampling process to generate noise per intensity level; and generating the noisy image by adding the generated noise per intensity level to the noise free image.
(9) The method of any one of features (1)-(8), in which the scene is a calibration chart comprising a plurality of exposure values.
(10) The method of any one of features (5)-(9), in which the generating the calibrated noise model based on the one or more noise sample sets further comprises: measuring a variance of each noise sample set; fitting a normal distribution to each noise sample set based on the variance to generate the calibrated noise model.
(11). An apparatus comprising: a memory storing one or more instructions; at least one processor operatively coupled to the memory and configured to execute one or more instructions stored in the memory, in which the one or more instructions, when executed by the at least one processor, cause the at least one processor to: collect a first set of images of a scene with a sensor in accordance with a first condition, collect a second set of images of the scene with the sensor in accordance with a second condition, collect one or more noise sample sets based on the first set of images and the second set of images, generate a calibrated noise model based on the one or more noise sample sets, and generate a noisy image by applying the calibrated noise model to a noise free image.
(12) The apparatus according to feature (11), in which the one or more instructions, when executed by the at least one processor, cause the at least one processor to: input the noisy image into a machine learning model to generate an estimated noise free image, and update the machine learning model based on comparing the estimated noise free image and the noise free image using a loss function.
(13) The apparatus according to feature (12), in which the machine learning model is a neural image signal processor (ISP) network.
(14) The apparatus according to any one of features (11)-(13), in which the one or more instructions, when executed by the at least one processor, to collect the first set of images in accordance with the first condition, cause the at least one processor to: collect a first burst of raw images of the scene with the sensor at a first International Organization Standardization (ISO) value, and in which the one or more instructions, when executed by the at least one processor, to collect the second set of images in accordance with the second condition, cause the at least one processor to: collect a second burst of raw images of the scene with the sensor at a second ISO value higher than the first ISO value.
(15) The apparatus according to feature (14), in which the scene comprises a plurality of intensity values, and in which the one or more instructions, when executed by the at least one processor, to collect the first set of images in accordance with the first condition, cause the at least one processor to: generate a ground-truth image by averaging each image in the first burst of raw images at each intensity value.
(16) The apparatus according to feature (15), in which the one or more instructions, when executed by the at least one processor, to collect the one or more noise sample sets based on the first set of images and the second set of images, cause the at least one processor to: for each intensity level in the ground-truth image, collect corresponding pixels from the second burst of images to form a noise sample set per intensity level.
(17) The apparatus according to feature (16), in which the one or more instructions, when executed by the at least one processor, to generate the calibrated noise model based on the one or more noise sample sets, cause the at least one processor to: generate a frequency histogram for each noise sample set, and converting the frequency histogram for each noise sample set to a probability mass function as the calibrated noise model.
(18) The apparatus according to feature (17), in which the one or more instructions, when executed by the at least one processor, to generate the noisy image, cause the at least one processor to: convert the calibrated noise model to one or more cumulative distribution functions invert the one or more cumulative distribution functions; perform, using the inverted one or more cumulative distribution functions, an inversion sampling process to generate noise per intensity level; and generate the noisy image by adding the generated noise per intensity level to the noise free image.
(19) The apparatus according to any one of features (11)-(18), in which the scene is a calibration chart comprising a plurality of exposure values.
(20) A non-transitory computer readable medium having instructions stored therein, which when executed by a processor cause the processor to execute a method comprising: collecting a first set of images of a scene with a sensor in accordance with a first condition; collecting a second set of images of the scene with the sensor in accordance with a second condition; collecting one or more noise sample sets based on the first set of images and the second set of images; generating a calibrated noise model based on the one or more noise sample sets; and generating a noisy image by applying the calibrated noise model to a noise free image.

What is claimed is:

1. A method performed by at least one processor, the method comprising:
collecting a first set of images of a scene with a sensor in accordance with a first condition;
collecting a second set of images of the scene with the sensor in accordance with a second condition;
collecting one or more noise sample sets based on the first set of images and the second set of images;
generating a calibrated noise model based on the one or more noise sample sets; and
generating a noisy image by applying the calibrated noise model to a noise free image.

2. The method according to claim 1, further comprising:
inputting the noisy image into a machine learning model to generate an estimated noise free image; and
updating the machine learning model based on comparing the estimated noise free image and the noise free image using a loss function.

3. The method of claim 2, wherein the machine learning model is a neural image signal processor (ISP) network.

4. The method according to claim 1,
wherein the collecting the first set of images in accordance with the first condition further comprises:
collecting a first burst of raw images of the scene with the sensor at a first International Organization Standardization (ISO) value, and
wherein the collecting the second set of images in accordance with the second condition further comprises:
collecting a second burst of raw images of the scene with the sensor at a second ISO value higher than the first ISO value.

5. The method of claim 4, wherein the scene comprises a plurality of intensity values, and
wherein the collecting the first set of images in accordance with the first condition further comprises:
generating a ground-truth image by averaging each image in the first burst of raw images at each intensity value.

6. The method of claim 5, wherein the collecting the one or more noise sample sets based on the first set of images and the second set of images further comprises:
for each intensity level in the ground-truth image, collecting corresponding pixels from the second burst of images to form a noise sample set per intensity level.

7. The method of claim 6, wherein the generating the calibrated noise model based on the one or more noise sample sets further comprises:
generating a frequency histogram for each noise sample set; and
converting the frequency histogram for each noise sample set to a probability mass function as the calibrated noise model.

8. The method of claim 7, wherein the generating the noisy image further comprises:
converting the calibrated noise model to one or more cumulative distribution functions;
inverting the one or more cumulative distribution functions;
performing, using the inverted one or more cumulative distribution functions, an inversion sampling process to generate noise per intensity level; and
generating the noisy image by adding the generated noise per intensity level to the noise free image.

9. The method of claim 1, wherein the scene is a calibration chart comprising a plurality of exposure values.

10. The method of claim 5, wherein the generating the calibrated noise model based on the one or more noise sample sets further comprises:
measuring a variance of each noise sample set;
fitting a normal distribution to each noise sample set based on the variance to generate the calibrated noise model.

11. An apparatus comprising:
a memory storing one or more instructions;
at least one processor operatively coupled to the memory and configured to execute one or more instructions stored in the memory,
wherein the one or more instructions, when executed by the at least one processor, cause the at least one processor to:
collect a first set of images of a scene with a sensor in accordance with a first condition,
collect a second set of images of the scene with the sensor in accordance with a second condition,
collect one or more noise sample sets based on the first set of images and the second set of images,
generate a calibrated noise model based on the one or more noise sample sets, and
generate a noisy image by applying the calibrated noise model to a noise free image.

12. The apparatus according to claim 11, wherein the one or more instructions, when executed by the at least one processor, cause the at least one processor to:
input the noisy image into a machine learning model to generate an estimated noise free image, and
update the machine learning model based on comparing the estimated noise free image and the noise free image using a loss function.

13. The apparatus according to claim 12, wherein the machine learning model is a neural image signal processor (ISP) network.

14. The apparatus according to claim 11, wherein the one or more instructions, when executed by the at least one processor, to collect the first set of images in accordance with the first condition, cause the at least one processor to:
collect a first burst of raw images of the scene with the sensor at a first International Organization Standardization (ISO) value, and
wherein the one or more instructions, when executed by the at least one processor, to collect the second set of images in accordance with the second condition, cause the at least one processor to:
collect a second burst of raw images of the scene with the sensor at a second ISO value higher than the first ISO value.

15. The apparatus according to claim 14, wherein the scene comprises a plurality of intensity values, and
wherein the one or more instructions, when executed by the at least one processor, to collect the first set of images in accordance with the first condition, cause the at least one processor to:
generate a ground-truth image by averaging each image in the first burst of raw images at each intensity value.

16. The apparatus according to claim 15, wherein the one or more instructions, when executed by the at least one processor, to collect the one or more noise sample sets based on the first set of images and the second set of images, cause the at least one processor to:
for each intensity level in the ground-truth image, collect corresponding pixels from the second burst of images to form a noise sample set per intensity level.

17. The apparatus according to claim 16, wherein the one or more instructions, when executed by the at least one processor, to generate the calibrated noise model based on the one or more noise sample sets, cause the at least one processor to:
generate a frequency histogram for each noise sample set, and
converting the frequency histogram for each noise sample set to a probability mass function as the calibrated noise model.

18. The apparatus according to claim 17, wherein the one or more instructions, when executed by the at least one processor, to generate the noisy image, cause the at least one processor to:
convert the calibrated noise model to one or more cumulative distribution functions;
invert the one or more cumulative distribution functions;
perform, using the inverted one or more cumulative distribution functions, an inversion sampling process to generate noise per intensity level; and
generate the noisy image by adding the generated noise per intensity level to the noise free image.

19. The apparatus according to claim 11, wherein the scene is a calibration chart comprising a plurality of exposure values.

20. A non-transitory computer readable medium having instructions stored therein, which when executed by a processor cause the processor to execute a method comprising:
collecting a first set of images of a scene with a sensor in accordance with a first condition;
collecting a second set of images of the scene with the sensor in accordance with a second condition;
collecting one or more noise sample sets based on the first set of images and the second set of images;
generating a calibrated noise model based on the one or more noise sample sets; and
generating a noisy image by applying the calibrated noise model to a noise free image.
